(19) United States
(12) Patent Application Publication
(10) Pub. No.: US 2003/0014757 A1
(43) Pub. Date: Jan. 16, 2003

(54) Modular multi-media converged services portal

(76) Inventors: Jeffrey A. Craven, Cumming, GA (US); Mark Bugajski, Norcross, GA (US)

Correspondence Address: ARRIS INTERNATIONAL, INC, 11450 TECHNOLOGY CIRCLE, DULUTH, GA, 30097, US

(21) Appl. No.: 10/167,952

(22) Filed: Jun. 12, 2002

Related U.S. Application Data
(60) Provisional application No. 60/304,134, filed on Jul. 10, 2001.

(51) Int. Cl. H04N 7/18; H04N 7/173; H04N 7/16; H04N 7/00; H04N 11/00

(52) U.S. Cl. 725/80; 348/552; 725/133; 725/141; 725/120

(57) ABSTRACT

A converged multi-media portal for coupling a plurality of multi-media signals carried on a single network medium to a plurality of corresponding multi-media devices includes a backplane, having a plurality of connectors, wherein the at least one connector is capable of accepting a network interface module. A plurality of the connectors are capable of accepting multi-media processing modules. Within the converged multi-media portal, the backplane enables communication between the network interface module and the multi-media processing modules disposed within the connectors. The network interface module receives at least one type of data signal and directs the at least one type of data signal to one of the multi-media processing modules according to a signal destination address. Each of the multi-media processing modules receives a multi-media signal from the network interface module and routes at least one multi-media signal to a corresponding multi-media device.

### BACKGROUND OF THE INVENTION

Many distribution networks are now being used to distribute entertainment content (e.g., broadcast television programming, movie channels), bi-directional data (e.g., internet access, e-mail services) and telephony (e.g., voice-over-internet protocol). These disparate forms of information (i.e., “multi-media”) can be carried together using a variety of transmission methodologies over a variety of media. Hybrid Fiber Coax, Fiber-to-the-home/curb/business, Fixed Wireless, Digital Subscriber Line, twisted copper wires are media types over which different information forms can be carried. Each transmission media and each transmission technology has certain strengths and weaknesses and for that reason, consumers that receive different services over different media need to have equipment that can be coupled to the media.

This creates a number of problems for end users. Different service providers means different bills, different payments schedules and different service departments from which help might need to be summoned.

It is anticipated that consumers will eventually want and expect all of their multi-media services from a single provider, such as a cable service provider. Convergence of disparate forms of information on a single media will eventually happen. When it does, consumers will still be faced with the technical challenge of recovering, distributing and using disparate information streams at the customer's premises.

A converged services portal, which enables end-users to quickly and economically add and/or delete multi-media services and enable them to readily enjoy disparate multi-media services would facilitate the adoption of multi-media service over distribution networks like existing cable television networks.

### BRIEF DESCRIPTION OF THE DRAWINGS

The teachings of the invention can be readily understood by considering the following detailed description in conjunction with the accompanied drawings, in which:

FIG. 1 illustrates a converged service portal block diagram, in accordance with one embodiment of the present invention;

FIG. 2 illustrates, in a perspective view, the backplane and plurality of connectors of the converged multi-media portal of the present invention;

FIG. 3 illustrates, in a perspective view, the backplane and plurality of connectors having a network interface module and a multi-media processing module attached thereon;

FIG. 4 illustrates the converged service portal of FIG. 2 having the network interface module and a plurality of multi-media processing modules contained thereon; and

FIG. 5 illustrates, in perspective view, a cabinet of the converged services portal in accordance with one embodiment of the present invention.

### DETAILED DESCRIPTION

There is provided herein, a modular converged multi-media services portal, which provides a modular interface between a distribution network, such as a cable television network and multi-media devices and equipment, such as computers, telephones, audio and video equipment, security and monitoring equipment, etc. The converged multi-media services portal includes a network interface device, which receives data from distribution network for a particular type of multi-media signal and routes the signal to the appropriate multi-media signal distribution unit.

Disparate bi-directional and uni-directional multi-media signals, which are embodied as different data streams on a distribution network, are processed by the network interface module. An incoming data stream of data packets (one that is sent into the portal from a distribution network) is routed by the network interface to an appropriate multi-media module. From there, the multi-media module recovers from the data packets of the data stream, a signal that can be used by multi-media-signal using devices.

By way of example, the information (i.e., program content) that would ordinarily be carried on a broadcast television RF signal, can be carried on a distribution network as a stream of data packets, the transmission of which comprises an information stream. The data packets that contain the broadcast television signal information are routed to a television multi-media module, which reconstructs a broadcast television radio frequency signal from the data packets and generates that signal for distribution at the customer premises and for demodulation by a standard broadcast television receiver.

Different multi-media services can be added or deleted to a consumer's premises by simply adding or removing different modular multi-media modules from the converged multi-media services portal. The converged multi-media services portal can be embodied as a weatherproof, outdoor cabinet or an indoor cabinet, wall-mounted or table-top modular enclosure housing the electronics for recovering multi-media signals at the customer premises from data streams provided from a distribution network.

The converged services portal can be used to deliver multiple lines of wired and/or wireless telephony, high-speed data, and/or multi-media services to either an end-user's home or office, referred to as a single dwelling unit or SDU. It can also be used at apartments or office complexes referred to as multiple dwelling unit or MDU. In either case, the converged multi-media services portal provides ready distribution of multi-media signals from a single distribution network source (e.g. xDSL, FTTx, HFC, Fixed Wireless, etc).

The converged multi-media services portal can support a variety of network interface options, including but not limited to, DOCSIS cable modem, Digital Subscriber Line modem, Fiber-to-the-x modem, or a fixed wireless modem. The converged multi-media services portal also supports modular multi-media modules that include, but are not limited to, powerline/802.11x/Ethernet/HomePNA access point, set-top box-like video module, IP streaming video module, network storage jukebox, voice-over-ip MTA, etc.

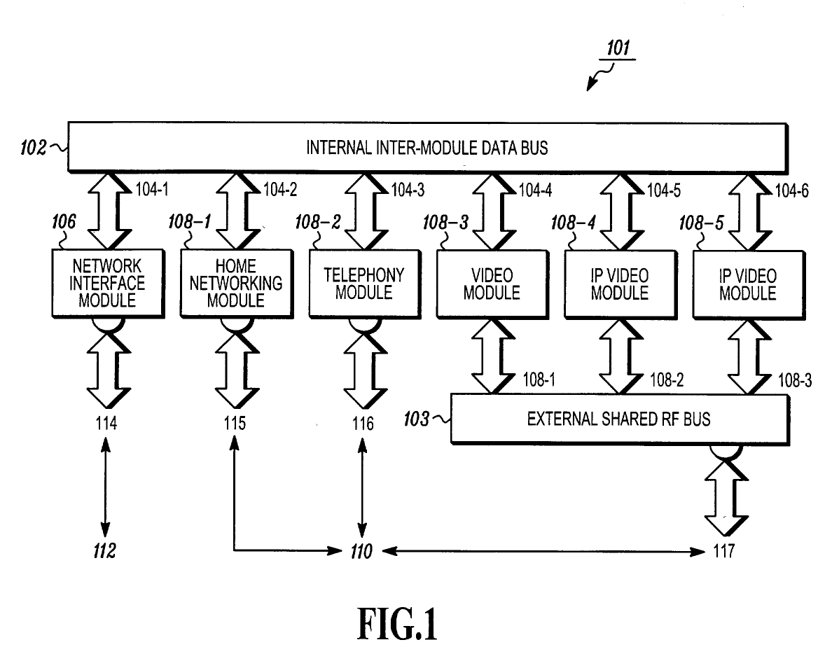

FIG. 1 illustrates a block diagram representing a converged multi-media services portal that provides for the addition or deletion of equipment required to take advantage of disparate multi-media information carried over a distribution network medium. The portal is comprised of a cabinet 101 that encloses a backplane 102, to which there are electrically and mechanically attached, several electrical connectors, six of which are shown and identified by reference numerals 104-1 through 104-6. The connectors are preferably comprised of electrically insulating material that fixes concealed electrical contacts that make electrical contact with mating conductive surfaces on a circuit board inserted into the connector. The connectors 104 and conductive pathways (not shown but well-known to those of skill in the art) on the backplane 102 enable signals to be exchanged, (i.e., transferred) between modules plugged into the various connectors.

The electrical connectors 104 accommodate at least one network interface module 106 and one or more multi-media processing modules 108. The multi-media modules typically receive data from the network interface module and generate from the received data, multi-media signals for use by a corresponding multi-media device. By way of example, one type of multi-media module can receive data packets from the network interface module that represent the content of a broadcast television program. When these data packets are received by a broadcast television multi-media processing module, it takes the data packets and can either re-create a broadcast television signal by converting the data to an analog signal and modulating it onto an RF carrier, or, it can take the data signal and create video and audio signals for a television.

Examples of different types of multi-media devices, each of which would be coupled to a corresponding multi-media module 108 are, television receivers or audio equipment, a telephone (POTS-type), a computer modem. Each multi-media processing module 108 is designed to generate a particular multi-media signal from the data it receives and each such module is therefore coupled to at least one corresponding multi-media device. Other embodiments of multi-media modules would include the ability to send data from a multi-media device, to the network interface module 106 for transmission onto the distribution network.

In a preferred embodiment, which contemplates the transmission and reception of multi-media signals using a transmission protocol such as TCP/UDP/IP to move data packets, the network interface module 106 acts like a bridge, directing data packets from various multi-media sources both within the home network 115 or distribution network 114 to the appropriate multi-media processing modules within the portal or distribution network 114 using source and/or destination address data embedded in data packets. All multi-media modules 108 will of course have an unique address to which data packets can be sent and from which data packets can be received.

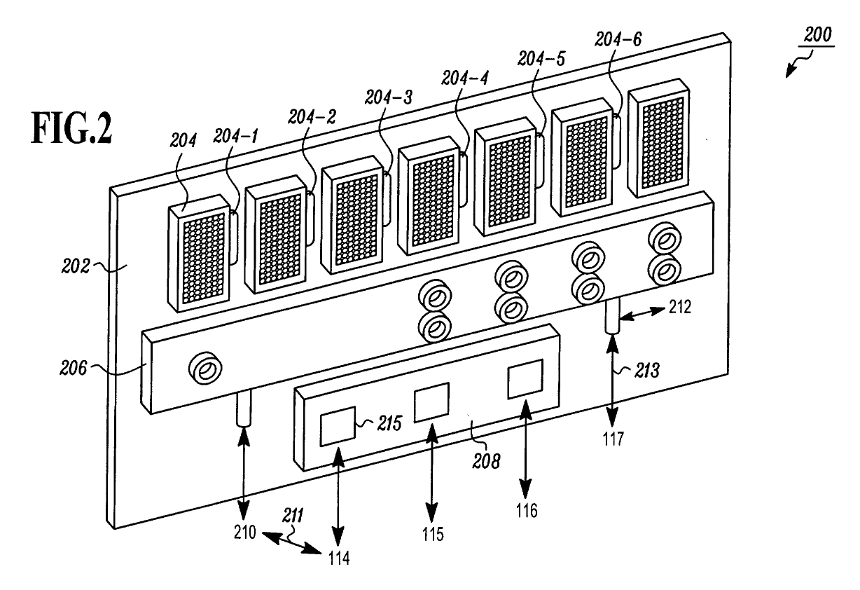

When installed into a connector 104 in the backplane 102, the multi-media modules 108 can be operatively coupled to corresponding multi-media devices (televisions, computers, cameras, etc., as set forth more fully below) throughout the customer's premises and be considered to be multi-media sources with respect to the multi-media devices in that each module receives its own data and from that data processes it to obtain a certain type of multi-media content or information. (The backplane identified in FIG. 1 by reference numeral 102 is also depicted in FIG. 2, where it is identified by reference numeral 202.)

Each of the electrical connectors 104-1 through 104-7 are coupled to electrical signal paths, such as conductive traces on or in a circuit board or discrete wires that form a bus over which data signals can be sent to, or received from other modules plugged into connectors at the same time. The electrically-conductive elements of the connectors 104-1 and 104-7 (well-known to those of skill in the art) can also be considered to be part of a bus. The electrical connectors 104-1 through 104-7 can be used to accommodate disparate multi-media processing modules of which there can be several different types, 108-1 through 108-6.

In the preferred embodiment, the connectors 104-1 through 104-7 are physical receptacles, capable of having the network interface module 106 or the multi-media processing modules 108-1-108-6 installed therein.

The converged multi-media services portal is preferably disposed within a cabinet 101, for conveniently and securely enclosing the multi-media service modules and the network interface module in a single, central location. If a user wishes to add or eliminate a multi-media service (presumably available on one or more media, such as a coaxial cable or fiber optic cable or two-way radio link, to which the network interface module is coupled) thereby necessitating adding or removing a multi-media processing module, the multi-media processing modules can be added or removed simply by installing the appropriate multi-media module in any available connector 104 or by removing the appropriate multi-media module, thereby eliminating the need for the addressability to the network interface module 106, the expense associated with a service call, as well as adjustments in interior wiring. Moreover, the converged multi-media services portal provides for a single network interface for a consumer's premises, whereby various multi-media devices may utilize a single network for convenient communication with an outside communication or service network.

In accordance with the preferred embodiment of the present invention, corresponding multi-media devices may include, but are not limited to, one or more personal computers, a personal digital assistant (PDA), a computer peripheral such as a printer or scanner, a fax machine, at least one web appliance, a heating, ventilation and air-conditioning system, lighting system, utility meters, security system, a fire extinguishing system, home gaming system, a television, a radio, audio device, intercom, household appliance, doors, windows, cameras, telephones, law sprinklers, or any other electronically controllable home system, all of which are well-known.

The backplane 102 is preferably any appropriate substrate to which the connectors 104 can be mounted and interconnected via conductive pathways between them. The conductive pathways (not shown) between connectors 104 can be in, or on the substrate. Although they are not shown in the figures, electrically conductive traces on a circuit board are well-known to those of skill in the art. Such traces are also known to be used to comprise a bus.

The connectors 104 (which are also known as edge connectors) and the backplane 102 function to couple together, circuits that can be mounted on various circuit boards plugged into the connectors 104. For purposes of claim construction, the term “module” should be construed to mean a circuit board or other substrate or carrier, (e.g., fiberglass, ceramic, resin, etc. or electrical conductors, such as pins or wires) that plugs into a mating connector 104, and any circuitry mounted thereon which performs one or more particular functions. The network interface module and multi-media processing modules are therefore considered to be circuit boards, substrates or other carriers. Some multi-media processing modules can send an information signal to the network interface module as well as exchange signals between them. The backplane 102 enables communication between the network interface module 106 and the multi-media processing modules 108-1 through 108-6.

In a preferred embodiment, the network interface module 106 receives transmission signals or data (e.g., TCP/UDP/IP data packets) 112 from a distribution network 114, such as, but not limited to, the service provider's network or Internet, although a wide-area network or Intranets are other forms of a distribution network. The signals of the distribution network are preferably sent via a media such as a coaxial cable, fiber optic cable, a hybrid-fiber coax network, wired or wireless transmission path.

The network interface module 106 receives the data signal 112 and distributes the multi-media signals contained therein to appropriate multi-media processing modules 108-1 through 108-6 using information from the data signal 112. Inasmuch as the multi-media signals are preferably TCP/UDP/IP, the particular multi-media processing modules to which a signal is to be routed can be determined by either a source address, a destination address or both. The multi-media signals are thus provided to the corresponding multi-media devices (e.g., a telephone, or voice-over-IP telephone, television, computer, PDA, camera, heating or air conditioning system, security system, etc.,) 110 according to information included with the multi-media signals, using wired or wireless connections provided at the consumer's premises.

As set forth above, the multi-media signals within the data signal 112 contain multi-media signal addresses, such as those used in the transmission control protocol/internet protocol (TCP/IP). Those of skill in the art will recognize that extended IPv6 addresses could be used as well.

By way of example, the network interface module 106 may receive a signal 112, containing packets of a first data stream for an Internet web browser as well as packets for a second data stream for a broadcast television channel. The first data stream for an internet web browser will need to be routed to a multi-media device that translates data packets (e.g. TCP/UDP/IP) for use by a personal computer. The network interface module 106 routes the data stream of the first multi-media signal to the first multi-media processing module 108-1 through connector 104-1, over the backplane 102, to connector 104-2. The network interface module 106 also routes the second data stream of the second multi-media signal to the third multi-media processing module 108-3, over the backplane 102 through the connector 104-1 and connector 104-4.

The first multi-media processing module 108-1 provides a first multi-media signal to the first multi-media device 110-1 (e.g., personal computer) and the third multi-media processing module 108-3 may provide the second multi-media signal to the third multi-media device 110-3 (e.g., a television receiver). Furthermore, the multi-media devices 110-1 through 110-3 may be in communication with each other across the backplane 102, via connectors 104-2 through 104-4, respectively. As well, the multi-media modules 108-1 through 108-6 may be in communication with each other across the backplane 102, via connectors 104-2 through 104-7, respectively.

As is well-known in data networks, upon the initialization of communication between one of the multi-media devices 110-1 through 110-3 and the distribution network (referred to herein as the distribution network 114), each multi-media processing module 108-1 through 108-6 can acquire a dynamically allocated address (e.g. TCP/UDP/IP). This address may be generated by, but not limited to, the network interface module 106 or derived via a system on the distribution network 114. This address is utilized by the distribution network 114 to properly and effectively transfer multi-media signals to the multi-media devices 110. While in a preferred embodiment, addresses are dynamically allocated, in an alternative embodiment, the multi-media processing modules 108-1 through 108-6 can contain a static address.

FIG. 2 illustrates, in perspective view, a converged services portal 200 having a backplane 202 and a plurality of connectors 204-1 through 204-7. The backplane 202 further includes a radio frequency (RF) bus or interface 206 and a wireline interface 208.

The radio frequency interface 206 includes a coaxial cable input connector 210 to receive a coaxial cable input, such as across a broadband connection using a coaxial cable 211 from the distribution network 114. The radio frequency interface 206 further includes a coaxial cable output connector 212 to provide an output data signal across a coaxial cable 213 to the home RF network 117. Moreover, the wire interface 208 may provide communication with the distribution network 114 across a wired connection 215.

The coaxial cable connectors 210 and 212 provide RF signal connection points and pathway to and from modules plugged into the connectors 204 of the backplane 202. An RF signal on a coaxial cable plugged into the connector 210 can be picked up by a network interface module 106 so as to enable the network interface module to process signals it recovers from the cable.

When a multi-media signal, such as signal 112 of FIG. 1, is provided to the backplane 202, the multi-media signal is provided to a network interface module 106 through the backplane 202. Access to the multi-media signals of a distribution network, such as a CATV network, can be provided by whatever media and communications protocol are used on the distribution network so long as the network interface module 106 can process the signals. As discussed above, the multi-media signal may be provided from the distribution network across a coaxial cable 211, a fiber optic cable, across a wired connection 215, or across a wireless communication network 217 via a wireless network interface module.

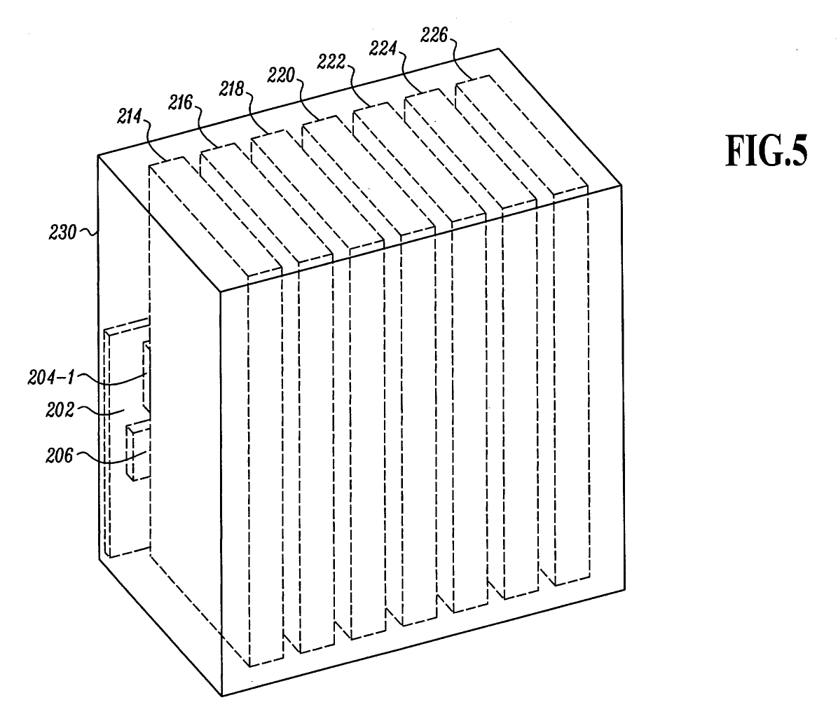

The backplane 202 electrically and physically supports the various connectors 204-1 through 204-7 so as to allow circuit boards, i.e., the aforementioned modules, to be mounted in them. The connectors 204-1 through 204-7 preferably can accept either a network interface module or one of a plurality of multi-media processing modules (not illustrated in FIG. 2). Furthermore, not shown for clarity purposes only, the converged services portal 200 is disposed within a cabinet, as discussed below with reference to FIG. 5.

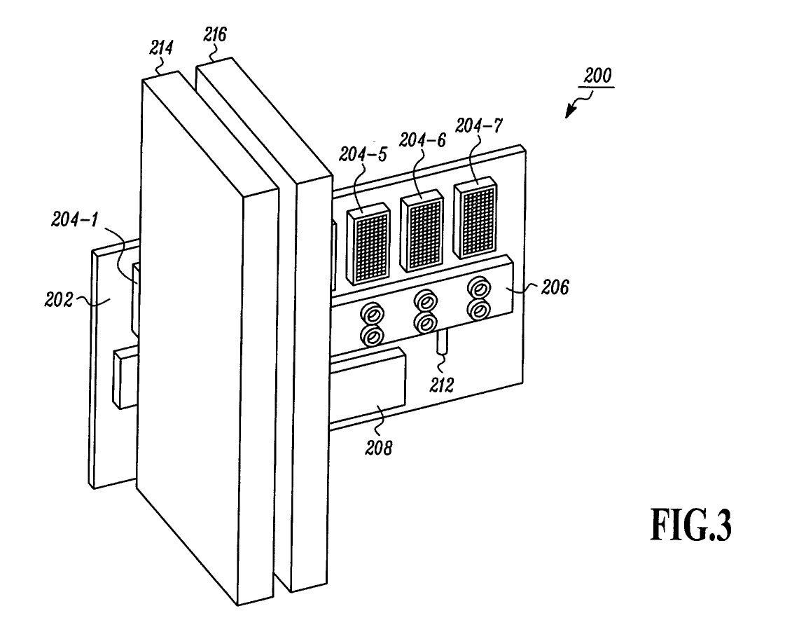

FIG. 3 illustrates the converged services portal 200 and the backplane 202 having a network interface module (identified in FIG. 3 by reference numeral 214) coupled into the first connector 204-1. FIG. 3 further illustrates a single multi-media processing module (identified in FIG. 3 by reference numeral 216) connected to the backplane 202 via a second connector, element 204-2 of FIG. 2, but not visible within FIG. 3. As shown, the backplane 202 may accept further multi-media processing modules in the connectors 204-2 through 204-7. For clarity purposes only, the connections between the backplane 202 and the distribution network, as discussed with reference to FIG. 2, have been omitted.

As set forth above, the network interface module 214 acts as a bridge between a multi-media device coupled to the multi-media processing module 216 and the distribution network 114, shown in FIG. 1. Inasmuch as the purpose of the disclosed and claimed invention is to facilitate the distribution and use of multi-media signals, the multi-media devices to which multi-media signals are delivered are preferably co-located at a subscriber's premises. Examples of co-located converged services portal and multi-media devices include, but are not limited to, a converged services portal mounted on an exterior wall, or in a utility closet of a subscriber's residence, to which a coaxial cable or fiber optic cable is connected. Multi-media devices of all kinds and used through out a residence needs only be wired to the cabinet to obtain disparate multi-media signals, without each device requiring its own addressability.

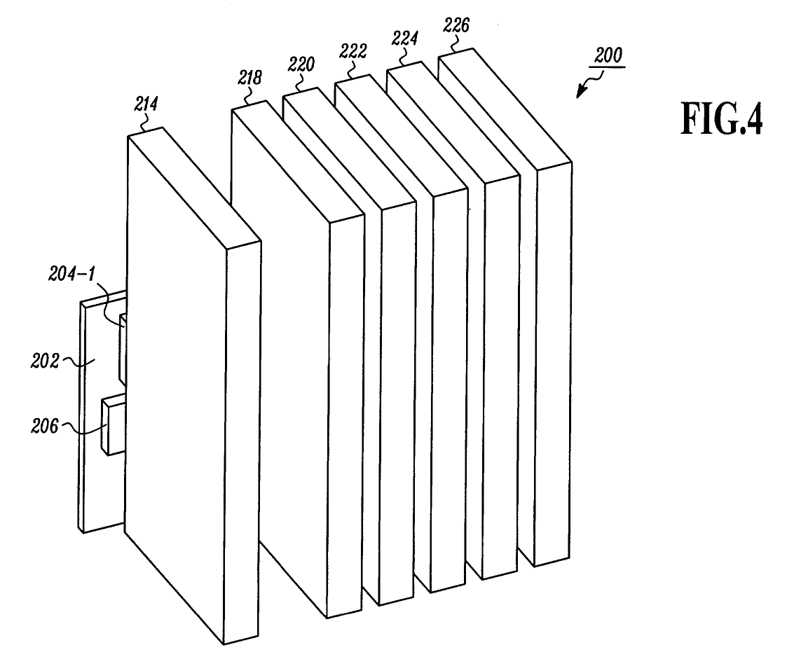

FIG. 4 illustrates the converged services portal 200 having the network interface module 214 shown in FIG. 3, and a plurality of multi-media processing modules 218-226 connected to corresponding connectors 204-1, 204-3 through 204-7 (not visible) on the backplane 202. As with FIG. 3, for clarity purposes only, the distribution network and communication paths, such as 211, 213, 215 and 217 have been omitted. In accordance with the present invention, the network interface module 214, is in communication with the multi-media processing modules 218-226 through the backplane 202.

As discussed above, a data signal, identified in FIG. 1 by reference numeral 112, can have different multi-media signals contained therein. The data signal 112 is received by the network interface module 214. The network interface module 214 routes the data packets of a multi-media signal to the corresponding multi-media processing module 218-226 based on embedded multi-media signal addresses. In other words, data packets of a television signal are routed to a television multi-media processing module; data packets for a web browser or an e-mail are routed to a cable modem or other modem module. Furthermore, the specific multi-media devices, such as 110 of FIG. 1, may be in communication with each other through the corresponding multi-media processing modules 218-226, across the backplane 202.

FIG. 5 illustrates a cabinet 230 having a converged services portal 200 disposed therein. For illustration purposes only, the converged services portal 200 is made visible through the cabinet, shown in phantom view. The cabinet 230 provides a closed environment for the converged services portal 200 to be disposed therein. In one embodiment of the present invention, the cabinet 230 is of a weather-resistant construction using weather-resistant materials. Such a cabinet could be used indoors or outdoors, wall-mounted or table top mounted.

The cabinet 230 may be constructed of a material allowing the box 230 to be installed indoors, such as within a housing unit, for example in close proximity to a fuse box. The cabinet 230 provides a closed environment having openings for an input coaxial cable line, an output coaxial cable line, power supply lines, wired lines, such as a telephone line, and a plurality of output transmission lines coupling the multi-media processing modules to the multi-media processing devices.

The present invention provides a converged services portal, which readily allows for disposition of multi-media signals at a multi-media subscribers (e.g., a consumer's) premises. Adding or deleting a multi-media service is readily accomplished by simply adding or deleting a multi-media processing module 216-226 and coupling a multi-media device 110 to the appropriate processing module, and thereafter enjoying the experience provided by the multi-media service. The present invention allows a user to quickly and inexpensively interchange network interface modules and multi-media processing modules within the converged services portal 200 without having to rewire an internal wiring system or otherwise adjust any internal connections to the plurality of multi-media devices, but rather simply open the cabinet 230 and insert a network processing module 214 or a multi-media processing module 218-226 therein.

It should be understood the present invention includes implementations of other variations and modifications of the invention and its various aspects as may be readily apparent to those of ordinary skill in the art, and that the invention is not limited by the specific embodiments described herein. It is therefore contemplated to cover by the present invention, any and all modifications, variations, or equivalence to fall within the spirit and scope of the basic underlying principles disclosed and claimed herein.

What is claimed is:

1. A converged multi-media portal for coupling a plurality of multi-media signals carried on a single network medium to a plurality of corresponding multi-media devices comprised of:
a backplane;
a plurality of connectors, operatively coupled to said backplane, the backplane enabling signals to be exchanged between connectors;
a network interface module, operatively coupled to a first connector, said network interface receiving from a distribution network medium, at least one type of data signal in which at least one multi-media signal is embedded, said network interface outputting a data signal; and
a multi-media processing module, operatively coupled to a second connector, receiving a data signal from said network interface module, said multi-media processing module creating from the data signal, a multi-media signal for use by a multi-media device and providing said multi-media signal to a corresponding multi-media device.

2. The converged multi-media portal of claim 1 further including a multi-media device, operatively coupled to said multi-media processing module.

3. The converged multi-media portal of claim 2 wherein said multi-media device includes at least one of: a computer; a personal digital assistant (PDA); a printer; a scanner; a fax machine, at least one web appliance; a heating, ventilation and air-conditioning system; a lighting system; a utility meter; a security system; a fire extinguishing system; a home gaming system; a television; a radio; audio device; intercom; household appliance; doors; windows; cameras; telephones; law sprinklers.

4. The converged multi-media portal of claim 1 further comprised of: a weatherproof cabinet, capable of being mounted outdoors.

5. The converged multi-media portal of claim 1 further comprised of: an indoor cabinet, capable of being used indoors.

6. The converged multi-media portal cabinet of claim 5 wherein said cabinet can be wall-mounted or table-top mounted.

7. A converged multi-media portal for coupling a plurality of multi-media signals carried on a network medium to a plurality of corresponding multi-media devices at a subscriber's premises comprised of:
a backplane comprised of a bus over which data signals can be carried;
a plurality of connectors, each of which is operatively coupled to said bus;
a network interface module, electrically and mechanically coupled to a first connector, said network interface also coupled to a distribution network medium, and receiving from the distribution network a signal that is at least one of: a TCP/IP signal; a UDP/IP signal; or equivalent data signal in which information of at least one multi-media information-bearing signal is embedded, the network interface module directing at least part of said signal to a predetermined one of the multi-media processing modules in a second connector that is coupled to said backplane; and
a multi-media processing module coupled to a second connector, said multi-media processing module receiving a signal from said network interface module, said multi-media processing module creating a multi-media signal from the data signal received from the network interface module and providing said multi-media signal to a corresponding multi-media device.

8. The converged multi-media portal of claim 7 further comprised of: a multi-media device co-located at said customer's premises, configured to be coupled to said multi-media module.

9. The converged multi-media portal of claim 8 wherein said multi-media device includes at least one of: a computer; a personal digital assistant (PDA); a printer; a scanner; a fax machine, at least one web appliance; a heating, ventilation and air-conditioning system; a lighting system; a utility meter; a security system; a fire extinguishing system; a home gaming system; a television; a radio; audio device; intercom; household appliance; doors; windows; cameras; telephones; lawn sprinklers.

10. The converged multi-media portal of claim 8 wherein said converged multi-media portal includes a cabinet enclosing: said backplane; said network interface module; said multi-media processing module.

11. The converged multi-media portal of claim 8 wherein said converged multi-media portal is capable of being shelf mounted and table-top mounted.

12. A converged multi-media portal for coupling a plurality of multi-media signals that include voice, video and data carried on a single network medium, to a distribution network, from a plurality of corresponding multi-media devices, comprised of:
a bus, over which signals can be carried;
a plurality of connectors electrically and mechanically coupled to said bus;
a first multi-media processing module operatively coupled to a first connector, said multi-media processing module also coupled to, and receiving multi-media signals from, a multi-media device, generating a data signal from said multi-media signals; and
a network interface module, operatively coupled to a second connector, receiving said data signal from said at least one multi-media processing module, and transmitting the data signal onto the distribution network.

13. The converged multi-media portal of claim 12 further including a second multi-media processing module, said first and second multi-media processing modules are capable of exchanging signals between each other.
